(19) United States
(12) Patent Application Publication
(10) Pub. No.: US 2026/0317220 A1
(43) Pub. Date: Oct. 15, 2026

(54) SYSTEMS AND METHODS FOR TREATING SEWAGE SLUDGE

(71) Applicant: MSDS Environmental Services LLC, Longwood, FL (US)

(72) Inventor: David Michael Clark, Highland Mills, NY (US)

(21) Appl. No.: 19/648,609

(22) Filed: Apr. 15, 2026

Related U.S. Application Data
(60) Provisional application No. 63/789,039, filed on Apr. 15, 2025.

(51) Int. Cl. C02F 11/06; C02F 11/121; C02F 11/148

(52) U.S. Cl. CPC C02F 11/06; C02F 11/121; C02F 11/148

(57) ABSTRACT

A system for treating sewage sludge includes a container configured to receive a volume of sewage sludge; a first delivery mechanism configured to deliver an acidic solution to the container to lower a pH of the volume of sewage sludge; a second delivery mechanism configured to deliver a treatment compound to the container; a third delivery mechanism configured to deliver an oxidizing agent to the container; a mixing apparatus configured to mix the treatment compound and the oxidizing agent with the volume of sewage sludge within the container; and an extraction unit configured to extract a cake formed as a result of solid-liquid separation within the container.

### INCORPORATION BY REFERENCE

This application claims the benefit of and priority to U.S. Provisional Patent Application No. 63/789,039 filed on Apr. 15, 2025, the entire content of which is incorporated by reference herein.

### TECHNICAL FIELD

The subject matter of the present disclosure relates generally to treating sewage sludge and related systems and methods of operation for reducing contaminants in sewage sludge, and in particular to systems and methods for treating sewage sludge by introducing an acidic solution, a treatment compound, and an oxidizing agent into sewage sludge within a container to promote pathogen reduction, odor-causing organic reduction, and solid-liquid separation, including configurations employing delivery mechanisms, mixing apparatuses, and extraction units for forming and removing a treated cake for disposal, further treatment, or beneficial reuse.

### BACKGROUND

Current sewage sludge treatment approaches often struggle to reliably reduce pathogens, odor-causing organics, and other contaminants to levels suitable for safe disposal or beneficial reuse. In many cases, untreated or insufficiently treated sewage sludge retains high levels of fecal coliforms, volatile organic compounds, heavy metals, and other undesirable constituents, which can create environmental, public health, and operational concerns. Conventional treatment techniques may also provide inconsistent results due to variations in sewage sludge composition, incomplete chemical contact, poor mixing, insufficient oxidation, or inadequate separation of solids from liquids. In addition, some existing processes may require multiple treatment stages, extended processing times, or specialized downstream handling before the treated material can be safely reused or disposed of, thereby increasing cost and operational complexity.

Accordingly, there remains a need for improved systems and methods for treating sewage sludge that provide effective and repeatable reduction of bacteria, odor-causing organics, and other contaminants while promoting solid-liquid separation and formation of a treated cake that can be more readily handled, further treated, disposed of, or beneficially reused. In particular, there is a need for systems and methods that use coordinated introduction of an acidic solution, a treatment compound, and an oxidizing agent into sewage sludge within a container, together with controlled mixing and extraction arrangements, to enhance treatment efficacy, improve contaminant reduction, and support production of treated material suitable for applications such as fertilizer or cement compounds.

### SUMMARY

In accordance with aspects of the disclosure, a system for treating sewage sludge includes a container configured to receive a volume of sewage sludge, a first delivery mechanism configured to deliver an acidic solution to the container to lower a pH of the volume of sewage sludge, a second delivery mechanism configured to deliver a treatment compound to the container, a third delivery mechanism configured to deliver an oxidizing agent to the container, a mixing apparatus configured to mix the treatment compound and the oxidizing agent with the volume of sewage sludge within the container, and an extraction unit configured to extract a cake formed as a result of solid-liquid separation within the container.

In an aspect of the present disclosure, the acidic solution may include a mixture of an inorganic acid and an organic acid, and may include muriatic acid, sulfuric acid, hydrochloric acid, nitric acid, phosphoric acid, lactic acid, citric acid, or a combination thereof.

In an aspect of the present disclosure, the first delivery mechanism may be connected to the container by a first connection member, the second delivery mechanism may be connected to the container by a second connection member, and the third delivery mechanism may be connected to the container by a third connection member.

In an aspect of the present disclosure, the container may be one of a concrete tank, a steel tank, a polymer tank, a batch reactor, a continuous stirred tank reactor, an anaerobic digester tank, or an aerobic digester tank.

In an aspect of the present disclosure, the first delivery mechanism may be configured to deliver the acidic solution to lower the pH of the sewage sludge to a value between about 2.9 and about 3.3.

In an aspect of the present disclosure, the first delivery mechanism may include a metering system configured to monitor and adjust pH in real time.

In an aspect of the present disclosure, the treatment compound may include aluminum sulfate, copper sulfate, and zinc sulfate, and the treatment compound may have a pH between about 1.9 and about 2.1.

In an aspect of the present disclosure, one of the first delivery mechanism, the second delivery mechanism, and the third delivery mechanism may be configured to deliver the acidic solution, the treatment compound, and the oxidizing agent, or two of the first delivery mechanism, the second delivery mechanism, and the third delivery mechanism may be configured to collectively deliver the acidic solution, the treatment compound, and the oxidizing agent.

In an aspect of the present disclosure, the oxidizing agent may include ozone, hydrogen peroxide, peracetic acid, potassium permanganate, sodium hypochlorite, chlorine dioxide, a persulfate, or a combination thereof.

In an aspect of the present disclosure, the extraction unit may include a dewatering device, and the dewatering device may be one of a filter press, a belt press, a centrifuge, and a screw press, or a bottom discharge port of the container.

In accordance with aspects of the disclosure, a method for treating sewage sludge includes introducing an acidic solution into a container containing a volume of sewage sludge to lower a pH of the volume of sewage sludge, introducing a treatment compound into the container, introducing an oxidizing agent into the container, mixing the treatment compound and the oxidizing agent with the volume of sewage sludge within the container, and extracting a cake formed as a result of solid-liquid separation within the container.

In an aspect of the present disclosure, the acidic solution may include a mixture of an inorganic acid and an organic acid.

In an aspect of the present disclosure, the method may further include lowering the pH of the sewage sludge to a value between about 2.9 and about 3.3.

In an aspect of the present disclosure, the treatment compound may include aluminum sulfate, copper sulfate, and zinc sulfate.

In an aspect of the present disclosure, the treatment compound may have a pH between about 1.9 and about 2.1.

In an aspect of the present disclosure, the oxidizing agent may include ozone, hydrogen peroxide, peracetic acid, potassium permanganate, sodium hypochlorite, chlorine dioxide, a persulfate, or a combination thereof.

In an aspect of the present disclosure, mixing may include aerating the sewage sludge.

In an aspect of the present disclosure, mixing may include operating a mechanical agitator positioned within the container.

In an aspect of the present disclosure, the method may further include treating the cake with an iron sponge to reduce a concentration of excess heavy metals and other chemical constituents retained in the cake.

In accordance with aspects of the disclosure, a system for treating sewage sludge includes a container configured to receive a volume of sewage sludge, with the container being one of a concrete tank, a steel tank, a polymer tank, a batch reactor, a continuous stirred tank reactor, an anaerobic digester tank, or an aerobic digester tank, a first delivery mechanism configured to deliver an acidic solution including a mixture of an inorganic acid and an organic acid to the container via a first connection member to lower a pH of the volume of sewage sludge to a value between about 2.9 and about 3.3, a second delivery mechanism configured to deliver a treatment compound including aluminum sulfate, copper sulfate, and zinc sulfate to the container via a second connection member, with the treatment compound having a pH between about 1.9 and about 2.1, a third delivery mechanism configured to deliver an oxidizing agent to the container via a third connection member, with the oxidizing agent including ozone, hydrogen peroxide, peracetic acid, potassium permanganate, sodium hypochlorite, chlorine dioxide, a persulfate, or a combination thereof, a mixing apparatus positioned within the container and configured to mix the treatment compound and the oxidizing agent with the volume of sewage sludge, with the mixing apparatus including an aerator or a mechanical agitator, and an extraction unit configured to extract a cake formed as a result of solid-liquid separation within the container, with the extraction unit including a dewatering device. One of the first delivery mechanism, the second delivery mechanism, and the third delivery mechanism may be configured to deliver the acidic solution, the treatment compound, and the oxidizing agent, or two of the first delivery mechanism, the second delivery mechanism, and the third delivery mechanism may be configured to collectively deliver the acidic solution, the treatment compound, and the oxidizing agent.

Further details and aspects of exemplary embodiments of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is a schematic of a system for treating sewage sludge, in accordance with aspects of the present disclosure;

FIG. 2 is a zoomed in perspective view of the system of FIG. 1, in accordance with aspects of the present disclosure;

FIG. 3 is a zoomed in perspective view of the system of FIG. 1, in accordance with aspects of the present disclosure;

FIG. 4A is an image of a user application for displaying results of the system of FIG. 1, in accordance with aspects of the present disclosure;

FIG. 4B is an image of the user application of FIG. 4A, in accordance with aspects of the present disclosure;

FIG. 5 is a flow diagram of a method for treating sewage sludge, in accordance with aspects of the present disclosure; and

FIG. 6 is a block diagram of a controller configured for use with the system of FIG. 1, in accordance with aspects of the present disclosure.

### DETAILED DESCRIPTION

The present disclosure relates generally to systems and methods for treating sewage sludge, and in particular to systems and methods for reducing pathogens, odor-causing compounds, and other contaminants in sewage sludge to improve handling, disposal, and reuse of treated material. The disclosed systems and methods provide coordinated treatment of sewage sludge to promote contaminant reduction and solid-liquid separation, thereby forming a treated cake that may be more safely disposed of, further processed, or beneficially reused. In some embodiments, the disclosed treatment approaches facilitate reduction of microbial content, organic pollutants, heavy metals, and emerging contaminants while improving the overall stability and usefulness of the treated sewage sludge.

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is therefore intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

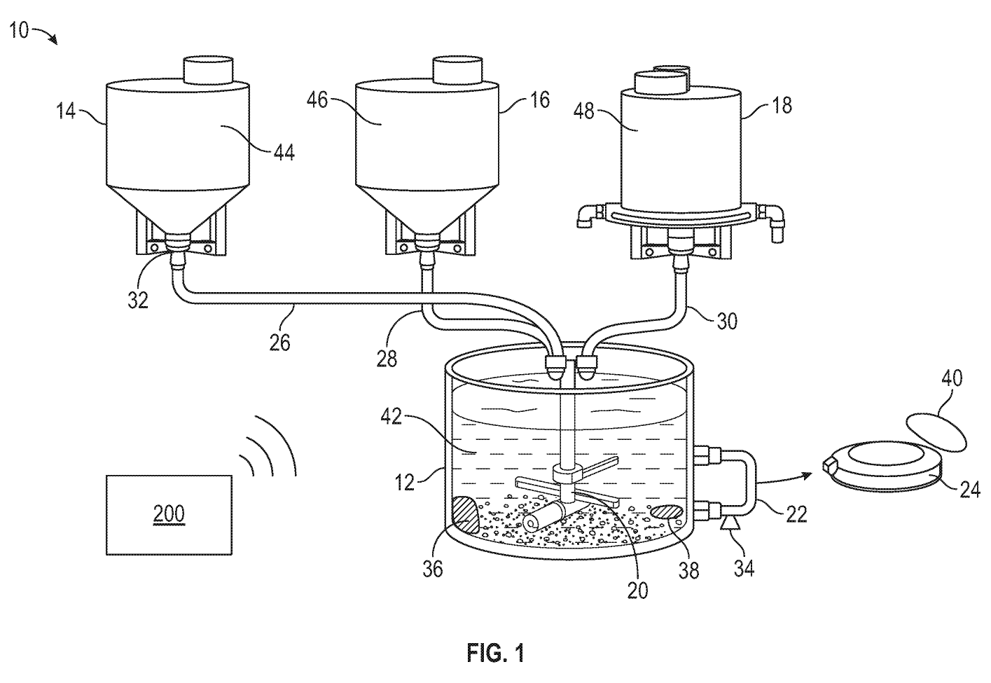

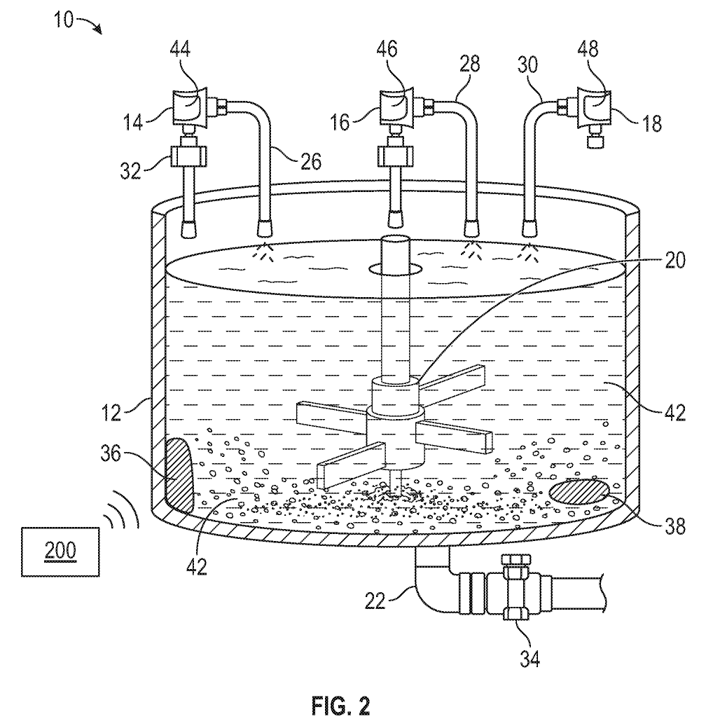

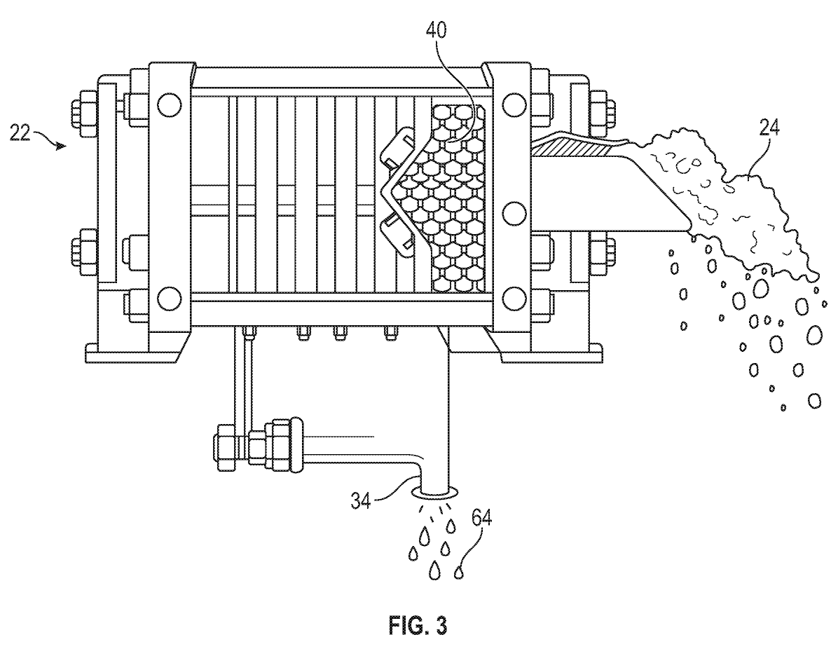

Referring to FIGS. 1-3, a system 10 for treating sewage sludge (FIG. 1) and zoomed in perspective views of the system 10 (FIGS. 2 and 3) are shown, in accordance with aspects of the present disclosure. System 10 includes a container 12, a first delivery mechanism 14, a second delivery mechanism 16, a third delivery mechanism 18, a mixing apparatus 20, an extraction unit 22, a cake 24, a first connection member 26, a second connection member 28, a third connection member 30, a metering system 32, a dewatering device 34, an aerator 36, a mechanical agitator 38, an iron sponge 40, a volume of sewage sludge 42, an acidic solution 44, a treatment compound 46, and an oxidizing agent 48. System 10 treats volume of sewage sludge 42 by coordinated chemical addition, mixing, and separation so that contaminants in volume of sewage sludge 42 are reduced and cake 24 is formed for extraction from container 12. System 10 is suitable for use with municipal sewage sludge, biosolids, digested sewage sludge, undigested sewage sludge, liquid biosolids, partially thickened sludge, and other sludge streams generated during wastewater treatment operations. In some applications, system 10 is installed at a wastewater treatment plant as a fixed treatment installation. In some applications, system 10 is provided as a skid-mounted or transportable treatment installation for temporary or distributed use. In some applications, system 10 is used to reduce fecal coliforms, odor-causing organics, volatile compounds, heavy metals, PFAS-related contaminants, PFOS, PFOA, and other undesirable constituents so that the treated material is more suitable for disposal, further treatment, or beneficial reuse.

Not all components shown or described with respect to system 10 are required in every embodiment of the present disclosure. In some embodiments, one or more of container 12, first delivery mechanism 14, second delivery mechanism 16, third delivery mechanism 18, mixing apparatus 20, extraction unit 22, metering system 32, dewatering device 34, aerator 36, mechanical agitator 38, or iron sponge 40 may be omitted, replaced, combined, repositioned, or otherwise modified depending on the intended application, treatment objectives, site conditions, sludge composition, or desired downstream use of cake 24. Accordingly, the illustrated and described arrangement of components is exemplary in nature, and other arrangements incorporating fewer components, additional components, or alternative components may also be employed without departing from the scope of the present disclosure.

Container 12 receives volume of sewage sludge 42 and provides the treatment volume within which acidic solution 44, treatment compound 46, and oxidizing agent 48 are introduced and mixed. Container 12 may be a concrete tank, a steel tank, a polymer tank, a batch reactor, a continuous stirred tank reactor, an anaerobic digester tank, or an aerobic digester tank. Container 12 may have a cylindrical configuration, a rectangular configuration, a hopper-bottom configuration, a conical-bottom configuration, or another geometry selected for the desired mixing pattern and solids-settling behavior. Container 12 may be open-topped, partially covered, or fully enclosed. Container 12 may be lined or coated to resist corrosion resulting from acidic solution 44, treatment compound 46, oxidizing agent 48, or byproducts generated during treatment. Suitable construction materials for container 12 include reinforced concrete, carbon steel, stainless steel, coated steel, fiberglass-reinforced polymers, polyethylene, polypropylene, and other corrosion-resistant structural materials. Container 12 may be sized for small batch treatment, pilot-scale treatment, or full-scale plant operation. In some embodiments, container 12 is sized to receive about 10,000 gallons of liquid biosolids, plus or minus about 3,000 gallons, although other treatment volumes may be used depending on plant throughput and application requirements. Container 12 may include internal baffles, sloped walls, drain regions, cleanout ports, sampling ports, manways, inspection openings, venting structures, and mounting features for mixing apparatus 20 and extraction unit 22. Container 12 may also include a lower collection region that promotes accumulation of solids during solid-liquid separation so that cake 24 can be removed more efficiently.

Volume of sewage sludge 42 may include sewage sludge from primary clarification, secondary clarification, digestion, dewatering operations, lagoon treatment, or combinations thereof. Volume of sewage sludge 42 may have a solids content ranging from relatively dilute sludge to thicker biosolids streams. In some embodiments, volume of sewage sludge 42 includes liquid biosolids having about 1.5% to about 3% solids. Volume of sewage sludge 42 may include fecal coliforms, pathogenic microorganisms, odor-causing organics, volatile organic compounds, hydrogen sulfide, ammonia derivatives, heavy metals, PFAS-related compounds, PFOS, PFOA, and other contaminants. Heavy metals present in volume of sewage sludge 42 or retained in cake 24 may include at least one of lead, mercury, cadmium, arsenic, chromium, nickel, copper, zinc, silver, molybdenum, selenium, or combinations thereof. Volume of sewage sludge 42 may vary significantly in pH, buffering capacity, organic loading, solids content, contaminant loading, and rheological behavior depending on its source and prior treatment history. System 10 is suitable for accommodating these variations by adjusting introduction of acidic solution 44, treatment compound 46, oxidizing agent 48, mixing conditions, and settling or dewatering conditions.

First delivery mechanism 14 introduces acidic solution 44 into container 12. First delivery mechanism 14 may be a pump-driven feed line, an injector assembly, a dosing line, a spray manifold, a sparging line, a gravity-fed line, or another liquid-addition structure selected for controlled addition of acidic solution 44. First delivery mechanism 14 may be permanently mounted to container 12 or removably coupled to container 12. First delivery mechanism 14 may be connected to container 12 by first connection member 26. First connection member 26 may be a pipe, hose, conduit, rigid tube, flexible tube, flange connection, threaded connection, clamped connection, welded connection, sealed port, nozzle assembly, or injector fitting. First delivery mechanism 14 may introduce acidic solution 44 continuously, intermittently, in pulses, or in one or more batch additions before, during, or after operation of mixing apparatus 20. First delivery mechanism 14 may be positioned near an upper region of container 12, along a sidewall of container 12, below a liquid level of volume of sewage sludge 42, or at multiple entry points to improve dispersion of acidic solution 44. First delivery mechanism 14 may also include valves, regulators, flow meters, pressure sensors, check valves, and backflow-prevention features.

Acidic solution 44 lowers the pH of volume of sewage sludge 42 and conditions volume of sewage sludge 42 for subsequent treatment with treatment compound 46 and oxidizing agent 48. Acidic solution 44 may include a mixture of an inorganic acid and an organic acid. Acidic solution 44 may include muriatic acid, sulfuric acid, hydrochloric acid, nitric acid, phosphoric acid, lactic acid, citric acid, or combinations thereof. Acidic solution 44 may be selected based on cost, desired pH range, reaction kinetics, buffering capacity of volume of sewage sludge 42, compatibility with treatment compound 46, compatibility with oxidizing agent 48, corrosion considerations, and downstream use or disposal requirements. Acidic solution 44 may be formulated to lower the pH of volume of sewage sludge 42 to a value between about 2.9 and about 3.3. In some embodiments, first delivery mechanism 14 delivers acidic solution 44 until volume of sewage sludge 42 reaches a target oxidation-reduction potential in addition to a target pH value. Acidic solution 44 may suppress biological activity, disrupt microbial cell structures, condition solids, release bound contaminants, reduce odors, and improve the effectiveness of later treatment stages. Acidic solution 44 may be introduced prior to addition of treatment compound 46 and oxidizing agent 48 so that volume of sewage sludge 42 is preconditioned before those materials are introduced. The acidic solution 44 may be added in a concentration sufficient to inhibit biological activity in the volume of sewage sludge 42.

Acidic solution 44 may be introduced into container 12 in a variety of ways depending on the treatment configuration and the characteristics of volume of sewage sludge 42. In some embodiments, acidic solution 44 is introduced continuously during a mixing process so that acidic solution 44 is distributed substantially uniformly throughout volume of sewage sludge 42 as the pH is reduced. In some embodiments, acidic solution 44 is introduced in one or more batch additions prior to mixing, during mixing, or after an initial mixing stage. In some embodiments, acidic solution 44 is introduced intermittently or in timed pulses in response to measured process conditions within container 12. First delivery mechanism 14 may therefore cooperate with metering system 32 to monitor pH and adjust delivery of acidic solution 44 in real time, thereby reducing the likelihood of over-acidification or under-acidification and improving treatment consistency across different batches of sewage sludge. In some embodiments, acidic solution 44 is introduced at one location within container 12, while in other embodiments acidic solution 44 is introduced at a plurality of locations within container 12 to improve distribution and reduce localized concentration gradients. In some embodiments, acidic solution 44 is introduced continuously during a mixing process carried out within container 12.

Pre-treating volume of sewage sludge 42 with acidic solution 44 prior to introduction of treatment compound 46 and oxidizing agent 48 may provide additional treatment benefits. In some embodiments, early acidification assists in breaking down complex organic matter, disrupting microbial biomass, enhancing the release of bound contaminants, and inhibiting undesirable microorganisms within volume of sewage sludge 42. Acidic solution 44 may also reduce odor formation, reduce ammonia volatilization, and alter rheological properties of volume of sewage sludge 42 in a manner that improves circulation and subsequent mixing within container 12. In some embodiments, acidic solution 44 establishes a chemical environment that improves the effectiveness of treatment compound 46 and oxidizing agent 48 in later treatment stages, thereby promoting more effective pathogen reduction, contaminant conditioning, and solid-liquid separation. The composition, concentration, delivery rate, and point of introduction of acidic solution 44 may therefore be selected based on the treatment objective, the initial composition of volume of sewage sludge 42, and the desired downstream handling, disposal, or reuse of cake 24.

Metering system 32 may be associated with first delivery mechanism 14 and may monitor and adjust pH in real time during addition of acidic solution 44. Metering system 32 may include one or more pH sensors, oxidation-reduction potential sensors, conductivity sensors, flow sensors, control valves, and dosing-control hardware. Metering system 32 may automatically increase or decrease delivery of acidic solution 44 in response to sensed conditions within container 12. Metering system 32 may also record treatment data, such as pH profiles over time, acid consumption, and batch history, for process control and quality assurance. Metering system 32 may be housed in a local control enclosure, integrated into a supervisory control system, or associated with an optional controller 200 discussed later in the disclosure. Real-time pH control by metering system 32 may reduce over-acidification, reduce reagent waste, improve treatment consistency, and accommodate variations in composition of volume of sewage sludge 42 from batch to batch.

Second delivery mechanism 16 introduces treatment compound 46 into container 12. Second delivery mechanism 16 may be a pump-driven feed system, a chemical feed line, an injector, a hopper-fed slurry line, a recirculating chemical loop, or another addition structure selected for the physical form of treatment compound 46. Second delivery mechanism 16 may be connected to container 12 by second connection member 28. Second connection member 28 may be a pipe, conduit, hose, fitting, nozzle, flange, manifold port, or another sealed coupling structure. Second delivery mechanism 16 may add treatment compound 46 after acidic solution 44 has reduced the pH of volume of sewage sludge 42, substantially concurrently with addition of acidic solution 44, or in staged additions. Second delivery mechanism 16 may introduce treatment compound 46 at one entry point or at multiple entry points around container 12 to improve distribution and reduce localized concentration gradients.

Treatment compound 46 conditions volume of sewage sludge 42 for contaminant reduction, solids conditioning, floc formation, precipitation, and antimicrobial activity. Treatment compound 46 may include aluminum sulfate, copper sulfate, and zinc sulfate. In some embodiments, treatment compound 46 includes aluminum sulfate as a majority component by weight. Treatment compound 46 may have a pH between about 1.9 and about 2.1. Treatment compound 46 may be prepared as a concentrated aqueous formulation, a dissolved formulation, a suspended formulation, or another chemically deliverable composition. In one representative embodiment, treatment compound 46 is prepared in an amount of about 84gallons intended for application to about 10,000 gallons of liquid biosolids, plus or minus about 3,000 gallons, and treatment compound 46 includes about 68 pounds of aluminum sulfate, plus or minus about 5 pounds, about 34 pounds of copper sulfate, plus or minus about 3 pounds, and about 8.5 pounds of zinc sulfate, plus or minus about 1 pound, mixed with about 80 gallons of water so that treatment compound 46 expands to about 84 gallons. This representative formulation corresponds to a metal sulfate ratio of about 8:4:1 by weight for aluminum sulfate, copper sulfate, and zinc sulfate. Other ratios and concentrations may be used depending on the treatment objective, sludge composition, solids loading, desired antimicrobial effect, desired precipitation effect, and compatibility with oxidizing agent 48. Treatment compound 46 may promote coagulation, flocculation, destabilization of suspended matter, precipitation of contaminants, phosphorus removal, antimicrobial activity, and improved downstream separation.

Treatment compound 46 may be formulated and prepared in different ways depending on the desired treatment scale, the solids content of volume of sewage sludge 42, the expected contaminant loading, and the intended mode of introduction into container 12. In some embodiments, treatment compound 46 is prepared off-site and transported to the treatment location in a ready-to-use form. In some embodiments, treatment compound 46 is prepared on site by combining one or more dry compounds with water to form a liquid or slurry formulation suitable for introduction through second delivery mechanism 16. In some embodiments, treatment compound 46 is mixed until one or more components are substantially dissolved. In some embodiments, treatment compound 46 is maintained as a suspension or partially dissolved mixture during delivery. The amount of water used in treatment compound 46, the order of addition of the components of treatment compound 46, and the degree of mixing used to prepare treatment compound 46 may vary depending on solubility, desired concentration, storage stability, and compatibility with second delivery mechanism 16. Treatment compound 46 may therefore be prepared as a relatively concentrated formulation for compact storage and transport, or as a more dilute formulation for easier pumping, dispersion, and mixing within container 12.

The relative amounts of aluminum sulfate, copper sulfate, and zinc sulfate in treatment compound 46 may vary depending on the treatment objective and the composition of volume of sewage sludge 42. In some embodiments, aluminum sulfate is used as a majority component by weight because aluminum sulfate may provide strong coagulation and floc-forming behavior that promotes solids conditioning and downstream separation. In some embodiments, copper sulfate and zinc sulfate are present in amounts selected to provide antimicrobial effects, contaminant-conditioning effects, or precipitation-related effects. In some embodiments, treatment compound 46 includes aluminum sulfate, copper sulfate, and zinc sulfate in a ratio greater than, less than, or approximately equal to about 8:4:1 by weight. In some embodiments, treatment compound 46 is selected so that one or more of the compounds is increased or decreased relative to the representative ratio depending on the initial microbial loading, odor level, solids content, heavy metal content, or expected reaction with oxidizing agent 48. Treatment compound 46 may therefore be tailored for different treatment sites, sludge types, contaminant profiles, and downstream reuse goals.

Introduction of treatment compound 46 into container 12 may be carried out in a variety of ways. In some embodiments, treatment compound 46 is introduced after acidic solution 44 has reduced the pH of volume of sewage sludge 42 to a selected value or range. In some embodiments, treatment compound 46 is introduced continuously during operation of mixing apparatus 20. In some embodiments, treatment compound 46 is introduced in one or more batch additions, in staged additions, or in timed pulses. In some embodiments, treatment compound 46 is introduced at one location within container 12. In some embodiments, treatment compound 46 is introduced at a plurality of locations within container 12 to improve dispersion, reduce localized concentration gradients, and improve contact with volume of sewage sludge 42. In some embodiments, treatment compound 46 is mixed with volume of sewage sludge 42 via aeration using aerator 36. In some embodiments, treatment compound 46 is mixed with volume of sewage sludge 42 using mechanical agitator 38 positioned within container 12. The timing, location, and rate of introduction of treatment compound 46 may therefore be selected to improve reaction efficiency, floc formation, contaminant destabilization, and subsequent solid-liquid separation.

Treatment compound 46 may provide multiple treatment effects within volume of sewage sludge 42. In some embodiments, treatment compound 46 promotes coagulation of suspended and colloidal matter, thereby destabilizing fine particles and encouraging formation of larger agglomerates or flocs. In some embodiments, treatment compound 46 assists in precipitation of contaminants present in dissolved or suspended form. In some embodiments, treatment compound 46 improves conditioning of solids so that later separation through settling, dewatering, or extraction is more effective. In some embodiments, treatment compound 46 contributes to reduction of phosphorus-related constituents. In some embodiments, treatment compound 46 provides antimicrobial activity that cooperates with acidic solution 44 and oxidizing agent 48 to reduce fecal coliforms and other microorganisms. Treatment compound 46 may therefore act not only as a chemical additive for solids conditioning, but also as a treatment chemistry that supports broader reduction of biological and chemical contaminants in volume of sewage sludge 42.

The pH of treatment compound 46 may be selected to support compatibility with acidic solution 44, compatibility with oxidizing agent 48, storage stability, and treatment performance. In some embodiments, treatment compound 46 has a pH between about 1.9 and about 2.1. In some embodiments, treatment compound 46 has a pH outside that range depending on the selected formulation, the amount of water used, and the desired interaction with volume of sewage sludge 42. A relatively low pH of treatment compound 46 may assist in maintaining a treatment environment favorable for contaminant reduction, solids conditioning, and microbial suppression. The pH, concentration, and component ratios of treatment compound 46 may therefore be selected together so that treatment compound 46 cooperates effectively with acidic solution 44 and oxidizing agent 48 during the treatment sequence.

In some embodiments, treatment compound 46 is selected based on the desired downstream handling, disposal, or reuse of cake 24. For example, treatment compound 46 may be selected to improve separation efficiency where cake 24 is intended for dewatering and disposal. In some embodiments, treatment compound 46 is selected to support production of a more stable cake 24 suitable for further treatment with iron sponge 40. In some embodiments, treatment compound 46 is selected to support beneficial reuse of cake 24 as a fertilizer compound, a cement compound, or another downstream product. The composition and amount of treatment compound 46 may therefore be selected based not only on immediate treatment performance within container 12, but also on the characteristics desired in cake 24 after extraction through extraction unit 22.

Third delivery mechanism 18 introduces oxidizing agent 48 into container 12. Third delivery mechanism 18 may be a gas injection system, liquid chemical feed line, sparging structure, injector line, manifold, or another addition arrangement selected based on the oxidizing chemistry used. Third delivery mechanism 18 may be connected to container 12 by third connection member 30. Third connection member 30 may be a pipe, tube, hose, diffuser line, nozzle port, flange, injector fitting, or another sealed connection. Third delivery mechanism 18 may add oxidizing agent 48 after addition of acidic solution 44 and treatment compound 46, simultaneously with treatment compound 46, or in a staged sequence. Third delivery mechanism 18 may add oxidizing agent 48 at one location or at multiple locations, including a plurality of corners or peripheral regions of container 12, to improve contact and reduce dead zones within volume of sewage sludge 42.

In some embodiments, first delivery mechanism 14, second delivery mechanism 16, and third delivery mechanism 18 may each be implemented as one or more pumps, metering pumps, dosing pumps, injector assemblies, feed lines, manifolds, valves, regulated gravity-feed arrangements, pressurized supply arrangements, sparging arrangements, eductors, recirculation-assisted feed systems, or combinations thereof. In some embodiments, first delivery mechanism 14, second delivery mechanism 16, and third delivery mechanism 18 are separate and independently controllable so that acidic solution 44, treatment compound 46, and oxidizing agent 48 may be introduced according to different rates, timings, pressures, or delivery profiles. In some embodiments, first delivery mechanism 14, second delivery mechanism 16, and third delivery mechanism 18 are sub-delivery mechanisms of a main delivery mechanism or integrated treatment skid. In some embodiments, one or more of first delivery mechanism 14, second delivery mechanism 16, and third delivery mechanism 18 share a common pump assembly, manifold, controller 200, support frame, storage structure, or supply enclosure.

The relative size, capacity, throughput, pressure rating, and dosing range of first delivery mechanism 14, second delivery mechanism 16, and third delivery mechanism 18 may differ from one another depending on the composition, viscosity, concentration, and desired feed rate of acidic solution 44, treatment compound 46, and oxidizing agent 48. In some embodiments, first delivery mechanism 14 is sized to deliver a larger volume of acidic solution 44 for pH adjustment of volume of sewage sludge 42, while second delivery mechanism 16 is sized to deliver treatment compound 46 as a concentrated formulation or slurry at a lower volumetric rate, and third delivery mechanism 18 is sized to deliver oxidizing agent 48 in gaseous, liquid, dissolved, or in situ generated form at a selected oxidation rate. In some embodiments, first delivery mechanism 14, second delivery mechanism 16, and third delivery mechanism 18 are scaled relative to one another based on treatment volume, sludge composition, desired chemical ratio, target pH range, target oxidation-reduction potential, residence time, or contaminant loading. In some embodiments, one or more of first delivery mechanism 14, second delivery mechanism 16, and third delivery mechanism 18 may be oversized to accommodate peak dosing conditions, batch treatment conditions, or future expansion of system 10.

In some embodiments, one or more of first delivery mechanism 14, second delivery mechanism 16, and third delivery mechanism 18 may be configured to deliver more than one of acidic solution 44, treatment compound 46, and oxidizing agent 48. For example, in some embodiments, a single delivery mechanism may be configured to deliver acidic solution 44, treatment compound 46, and oxidizing agent 48 to container 12. In some embodiments, two delivery mechanisms may collectively deliver acidic solution 44, treatment compound 46, and oxidizing agent 48, such that one delivery mechanism delivers two of acidic solution 44, treatment compound 46, and oxidizing agent 48 and another delivery mechanism delivers the remaining one thereof. The particular number and arrangement of delivery mechanisms may be selected based on system layout, cost, site conditions, chemical-compatibility considerations, dosing strategy, or other implementation preferences.

In some embodiments, first connection member 26, second connection member 28, and third connection member 30 may each include one or more pipes, hoses, conduits, tubes, feed lines, injector lines, manifolds, fittings, nozzles, diffusers, spargers, flanges, threaded couplings, clamped couplings, welded joints, quick-connect couplings, sealed ports, or combinations thereof. In some embodiments, first connection member 26, second connection member 28, and third connection member 30 are rigid. In some embodiments, first connection member 26, second connection member 28, and third connection member 30 are flexible. In some embodiments, one or more of first connection member 26, second connection member 28, and third connection member 30 include corrosion-resistant materials selected based on the chemistry carried therethrough, including stainless steel, coated steel, polymer tubing, reinforced hose, fluoropolymer-lined conduit, fiberglass-reinforced structures, or other chemically compatible materials.

The relative dimensions, cross-sectional areas, lengths, wall thicknesses, pressure ratings, and flow capacities of first connection member 26, second connection member 28, and third connection member 30 may differ from one another depending on the associated delivery duty of first delivery mechanism 14, second delivery mechanism 16, and third delivery mechanism 18. In some embodiments, first connection member 26 is sized for delivery of acidic solution 44 at a first flow rate, second connection member 28 is sized for delivery of treatment compound 46 at a second flow rate, and third connection member 30 is sized for delivery of oxidizing agent 48 at a third flow rate, with the first, second, and third flow rates being the same or different. In some embodiments, one or more of first connection member 26, second connection member 28, and third connection member 30 include multiple branches or multiple injection points into container 12 so that the associated chemical is distributed at a plurality of locations. In some embodiments, one or more of first connection member 26, second connection member 28, and third connection member 30 include valves, backflow preventers, sensors, flow meters, pressure regulators, or isolation structures positioned along the flow path.

Oxidizing agent 48 promotes oxidation of contaminants, disruption of microbial cells, reduction of odors, and improvement of dewaterability and contaminant removal. Oxidizing agent 48 may include ozone, hydrogen peroxide, peracetic acid, potassium permanganate, sodium hypochlorite, chlorine dioxide, a persulfate, or combinations thereof. Oxidizing agent 48 may be introduced in gaseous form, liquid form, dissolved form, or generated in situ. In some embodiments, oxidizing agent 48 is ozone delivered through a sparging or injection arrangement. In embodiments, oxidizing agent 48 is ozone delivered through a sparging or injection arrangement. In some embodiments, oxidizing agent 48 is delivered at a rate of about 0.05 grams per hour to about 5 grams per hour per 1,000 gallons of volume of sewage sludge 42 being treated, although other feed rates may be used based on treatment scale and contaminant loading. Oxidizing agent 48 may oxidize reduced sulfur compounds, organic matter, microbial material, and odor-causing compounds such as hydrogen sulfide and ammonia-related species. Oxidizing agent 48 may also interact with treatment compound 46 to promote more effective contaminant destabilization and separation. Third delivery mechanism 18 may be configured so that oxidizing agent 48 is added after volume of sewage sludge 42 has already been conditioned by acidic solution 44 and treatment compound 46, thereby promoting a coordinated treatment sequence.

Oxidizing agent 48 may be selected based on the treatment objective, the composition of volume of sewage sludge 42, the expected microbial loading, the degree of odor control desired, the compatibility of oxidizing agent 48 with treatment compound 46, the materials of construction of container 12 and third delivery mechanism 18, site safety considerations, chemical availability, storage requirements, and downstream handling or reuse requirements for cake 24. In some embodiments, oxidizing agent 48 is selected to provide relatively rapid oxidation of odor-causing compounds and microbial material. In some embodiments, oxidizing agent 48 is selected to provide a more persistent oxidative treatment effect over a longer contact period. In some embodiments, oxidizing agent 48 is selected to balance oxidation strength with ease of storage, transport, and on-site handling. Different oxidizing chemistries may therefore be used for different treatment sites, different sludge compositions, and different operating conditions.

Oxidizing agent 48 may be prepared, delivered, or generated in different ways depending on the selected chemistry. In some embodiments, oxidizing agent 48 is supplied from a stored liquid source and delivered through third delivery mechanism 18 to container 12. In some embodiments, oxidizing agent 48 is supplied from a stored gas source or generated gas source and introduced through a sparging arrangement, a diffuser, or another gas-dispersion structure. In some embodiments, oxidizing agent 48 is generated in situ at the treatment site and then introduced into container 12 substantially as needed. In some embodiments, oxidizing agent 48 is introduced in dissolved form within a carrier liquid. In some embodiments, oxidizing agent 48 is introduced continuously during a treatment interval. In some embodiments, oxidizing agent 48 is introduced intermittently, in one or more pulses, in one or more batch additions, or according to a staged dosing profile. The physical form, concentration, and delivery rate of oxidizing agent 48 may therefore be selected based on treatment scale, reaction kinetics, contact efficiency, and compatibility with third delivery mechanism 18 and mixing apparatus 20.

Introduction of oxidizing agent 48 into container 12 may be carried out at one location or at a plurality of locations depending on the geometry of container 12 and the desired distribution of oxidizing chemistry within volume of sewage sludge 42. In some embodiments, oxidizing agent 48 is introduced at a plurality of corners or peripheral regions of container 12 so that oxidizing agent 48 reaches regions that might otherwise experience reduced circulation or reduced chemical contact. In some embodiments, oxidizing agent 48 is introduced near a lower region of container 12, near a sidewall of container 12, near an upper region of container 12, or at distributed injection points positioned to improve contact efficiency. In some embodiments, oxidizing agent 48 is introduced through a sparging arrangement that also assists with mixing of volume of sewage sludge 42. In some embodiments, oxidizing agent 48 is introduced through third connection member 30 and is then dispersed through operation of aerator 36, mechanical agitator 38, or both. The point or points of introduction of oxidizing agent 48 may therefore be selected to reduce dead zones, improve oxidation uniformity, and improve the overall efficiency of treatment.

Oxidizing agent 48 may be introduced after volume of sewage sludge 42 has been conditioned by acidic solution 44 and treatment compound 46 so that the treatment sequence proceeds in a coordinated manner. In some embodiments, acidic solution 44 first reduces the pH of volume of sewage sludge 42 and conditions volume of sewage sludge 42 for further reaction. In some embodiments, treatment compound 46 is then introduced to promote coagulation, contaminant conditioning, floc formation, precipitation, and antimicrobial effects. In some embodiments, oxidizing agent 48 is then introduced to further disrupt microbial cells, oxidize reduced compounds, reduce odors, and improve downstream separation. In some embodiments, oxidizing agent 48 is introduced during mixing of treatment compound 46 with volume of sewage sludge 42. In some embodiments, oxidizing agent 48 is introduced after an initial treatment interval involving treatment compound 46. In some embodiments, oxidizing agent 48 and treatment compound 46 are introduced in a two-step process in which one is added and mixed before the other is added and mixed. The sequence, timing, and duration of introduction of oxidizing agent 48 may therefore be selected based on desired pathogen reduction, odor control, contaminant oxidation, and separation performance.

Oxidizing agent 48 may provide multiple treatment effects within volume of sewage sludge 42. In some embodiments, oxidizing agent 48 oxidizes reduced sulfur compounds, organic matter, microbial material, and odor-causing compounds such as hydrogen sulfide and ammonia-related species. In some embodiments, oxidizing agent 48 assists in destruction or inactivation of fecal coliforms and other microorganisms. In some embodiments, oxidizing agent 48 alters the physical and chemical characteristics of solids within volume of sewage sludge 42 so that downstream dewatering and extraction of cake 24 are improved. In some embodiments, oxidizing agent 48 cooperates with treatment compound 46 to destabilize suspended matter, condition solids, and improve precipitation or capture of contaminants. Oxidizing agent 48 may therefore contribute not only to disinfection and odor reduction, but also to solids conditioning, contaminant reduction, and improvement of the quality of cake 24 formed during solid-liquid separation.

The amount and feed rate of oxidizing agent 48 may vary depending on treatment scale, contaminant loading, solids content, microbial loading, odor intensity, and the selected oxidizing chemistry. In some embodiments, oxidizing agent 48 is introduced at a rate of about 3 grams to about 5 grams per hour. In some embodiments, oxidizing agent 48 is introduced at a rate outside that range depending on treatment volume, site conditions, and desired treatment results. In some embodiments, the dosing of oxidizing agent 48 is selected to provide a target oxidation-reduction potential within container 12. In some embodiments, the dosing of oxidizing agent 48 is selected in relation to the amount of treatment compound 46 and the amount or composition of acidic solution 44. In some embodiments, the dosing of oxidizing agent 48 is adjusted in response to measured process conditions, including pH, oxidation-reduction potential, odor level, contaminant level, or a visual or analytical indication of separation performance. The selected amount of oxidizing agent 48 may therefore be tailored to the specific treatment environment and the desired characteristics of cake 24 and any separated liquid fraction, such as a treated filtrate 64.

Oxidizing agent 48 may also be selected in view of the intended downstream handling, disposal, or reuse of cake 24. In some embodiments, oxidizing agent 48 is selected to improve pathogen reduction where cake 24 is intended for beneficial reuse. In some embodiments, oxidizing agent 48 is selected to improve odor reduction and solids stabilization where cake 24 is intended for transport or disposal. In some embodiments, oxidizing agent 48 is selected to support production of a more stable and more manageable cake 24 suitable for dewatering through dewatering device 34. In some embodiments, oxidizing agent 48 is selected to cooperate with later treatment of cake 24 using iron sponge 40 or with later conversion of cake 24 into a fertilizer compound, a cement compound, or another reusable material. The oxidizing chemistry, delivery mode, and dosing profile of oxidizing agent 48 may therefore be selected based not only on in-container treatment performance, but also on desired downstream outcomes for the treated material.

Mixing apparatus 20 distributes acidic solution 44, treatment compound 46, and oxidizing agent 48 through volume of sewage sludge 42 and promotes reaction, conditioning, and separation. Mixing apparatus 20 may include an aerator 36, a mechanical agitator 38, or both. Mixing apparatus 20 may be positioned within container 12, mounted to a top region of container 12, mounted through a sidewall of container 12, or coupled externally with a driven shaft or recirculation loop. Mixing apparatus 20 may be operated continuously or intermittently. Mixing apparatus 20 may provide mixing before addition of treatment chemicals, during addition of treatment chemicals, after addition of treatment chemicals, or during multiple stages of the treatment cycle. Mixing apparatus 20 may be selected based on the viscosity of volume of sewage sludge 42, solids concentration, tank geometry, treatment scale, and desired shear conditions. Mixing apparatus 20 may also be selected to avoid excessive shear that could break flocs after they are formed. In some embodiments, mixing apparatus 20 includes a propeller agitator, a turbine agitator, a paddle agitator, an anchor agitator, a jet mixer, a magnetic agitator, a coarse-bubble aeration device, a fine-bubble aeration device, a sparging arrangement, or combinations thereof. The particular form of mixing apparatus 20 may be selected based on the characteristics of volume of sewage sludge 42 and the desired degree of circulation, dispersion, aeration, and solids suspension within container 12.

Aerator 36 may inject air or another gas into volume of sewage sludge 42 to promote circulation, enhance mixing, increase oxygen availability where desired, improve contact between treatment compound 46 and oxidizing agent 48 and volume of sewage sludge 42, and reduce odor-causing anaerobic conditions. Aerator 36 may be a diffuser, sparger, coarse-bubble aerator, fine-bubble aerator, jet aerator, or another gas-dispersion structure. Aerator 36 may be positioned at a lower region of container 12, along a sidewall of container 12, or at multiple distributed positions. Aerator 36 may also function as a delivery structure for gaseous oxidizing agent 48 in embodiments using ozone or other oxidizing gases. Aerator 36 may provide both mixing and oxidation-related support in a combined treatment mode.

Mechanical agitator 38 may be a propeller agitator, turbine agitator, paddle agitator, anchor agitator, jet mixer, magnetic agitator, or another rotating or driven mixing structure. Mechanical agitator 38 may include one or more shafts, one or more impellers, one or more paddles, and a drive motor. Mechanical agitator 38 may operate at fixed speed or variable speed. Mechanical agitator 38 may provide axial flow, radial flow, tangential flow, or mixed flow within container 12. Mechanical agitator 38 may be used alone or in combination with aerator 36. Mechanical agitator 38 may be particularly useful where volume of sewage sludge 42 has higher solids content, higher viscosity, or a stronger tendency to settle or stratify. Mechanical agitator 38 may also be used during introduction of acidic solution 44 to improve pH uniformity and during introduction of treatment compound 46 and oxidizing agent 48 to improve reaction uniformity.

System 10 may use a one-stage or multi-stage mixing sequence. In one approach, treatment compound 46 and oxidizing agent 48 are mixed with volume of sewage sludge 42 together. In another approach, treatment compound 46 is first mixed with volume of sewage sludge 42 and oxidizing agent 48 is added and mixed later. In another approach, oxidizing agent 48 is first mixed with volume of sewage sludge 42 and treatment compound 46 is added and mixed later. Mixing duration, shear intensity, aeration rate, impeller speed, and sequence may all be selected based on treatment objectives. After the desired degree of reaction and conditioning has occurred, container 12 may be allowed to settle for a predetermined period so that solids-liquid separation progresses and cake 24 develops.

Extraction unit 22 removes cake 24 after solid-liquid separation has occurred within container 12. Extraction unit 22 may include dewatering device 34, a bottom discharge port, a suction-based withdrawal structure, a vacuum-assisted structure, or another solids-removal arrangement. Extraction unit 22 may be integrated directly with container 12 or may receive conditioned material through a transfer line from container 12. Extraction unit 22 may remove cake 24 after a settling interval, during continuous treatment, or after partial thickening within container 12. In some embodiments, operation of system 10 produces, in addition to cake 24, a separated liquid fraction, such as the treated filtrate 64 (FIG. 3), that is treated during the disclosed process and may be collected for discharge, further treatment, polishing, or beneficial reuse. Extraction unit 22 may also remove a liquid fraction separately from a solids fraction. Extraction unit 22 may discharge cake 24 to a collection area, conveyor, bin, truck, secondary treatment unit, drying system, pelletizing system, fertilizer-processing system, or cement-feed system.

Dewatering device 34 may be a filter press, a belt press, a centrifuge, a screw press, or another dewatering machine selected for the desired dryness and throughput of cake 24. Dewatering device 34 may use pressure, gravity, centrifugal force, screw compression, filtration media, or combinations thereof. Dewatering device 34 may receive partially separated material from container 12 and further reduce water content so that cake 24 is easier to handle and transport. Dewatering device 34 may also generate treated filtrate 64 or liquid discharge that can be returned to a treatment process, collected for further treatment, or separately disposed of. In embodiments using a bottom discharge port instead of or in addition to dewatering device 34, container 12 may release solids-enriched material by gravity or by pumped withdrawal from a lower region of container 12.

Cake 24 is the semi-solid or solid material formed as a result of solid-liquid separation within container 12 and extraction through extraction unit 22. Cake 24 may contain reduced biological activity relative to untreated volume of sewage sludge 42. Cake 24 may include concentrated solids, residual organics, precipitated contaminants, and reduced water content. Cake 24 may contain contaminants that have been destabilized, precipitated, captured, or otherwise transferred from the bulk liquid phase during treatment. In some embodiments, cake 24 includes a concentrated portion of contaminants removed from volume of sewage sludge 42 during treatment, including bacteria, organic compounds, and chemical constituents. Cake 24 may include residual fecal coliforms, volatile organic compounds, heavy metals, PFAS-related compounds, PFOS, PFOA, odor-causing compounds, and other constituents at reduced levels relative to untreated material. In some embodiments, treatment carried out using system 10 reduces fecal coliform concentration to less than about 100 Most Probable Number (MPN) per 100 mL. In some embodiments, treatment carried out using system 10 reduces fecal coliform concentration from about 1986.3 MPN per 100 mL to less than about 1 MPN per 100 mL after about 20 to 30 minutes of treatment and settling. In some embodiments, heavy metals such as molybdenum, nickel, selenium, chromium, arsenic, cadmium, and lead are reduced to non-detectable levels in cake 24 according to representative test results. In some embodiments, PFOS and PFOA are reported as non-detectable at a reporting limit of about 0.49 micrograms per kilogram dry weight. Cake 24 may then be disposed of, further processed, or beneficially reused. In some embodiments, the odor-causing compounds retained in cake 24 include hydrogen sulfide, ammonia derivatives, or both.

The foregoing results show that the treatment process can reduce both biological contaminants and chemical contaminants in cake 24 to levels substantially below those present in untreated volume of sewage sludge 42. Reduction of fecal coliform concentration to less than about 100 MPN per 100 mL, and in some embodiments to less than about 1 MPN per 100 mL after about 20 to 30 minutes of treatment and settling, shows that the disclosed combination of treatment compound 46 and oxidizing agent 48 can provide a high degree of pathogen reduction within a relatively short treatment interval. Reduction of heavy metals such as molybdenum, nickel, selenium, chromium, arsenic, cadmium, and lead to non-detectable levels in representative treated cake 24 shows that the treatment process can reduce or stabilize hazardous metal constituents that are commonly associated with environmental and public-health concerns. Reporting PFOS and PFOA as non-detectable at representative reporting limits shows that the treatment process can also address persistent PFAS-related contaminants that are often difficult to remove through conventional sewage sludge treatment approaches. Together, these results show that cake 24 may have lower pathogen content, lower heavy metal content, lower PFAS-related contaminant content, and lower odor-causing contaminant content than untreated material, which may broaden the available options for disposal, further processing, and beneficial reuse.

Iron sponge 40 may be used in a further treatment stage applied to cake 24 after extraction. Iron sponge 40 may reduce a concentration of excess heavy metals and other retained chemical constituents in cake 24. Iron sponge 40 may be introduced in a contact bed, treatment vessel, blend stage, or polishing stage after dewatering. Iron sponge 40 may adsorb, bind, or stabilize heavy metals so that cake 24 is safer for disposal or reuse. Iron sponge 40 may be used where a more stringent post-treatment polishing step is desired for regulatory compliance or commercial reuse. Cake 24 treated with iron sponge 40 may be directed to fertilizer manufacture, cement-related reuse, land application, landfill disposal, thermal treatment, or other downstream pathways depending on local requirements and product objectives.

In some embodiments, post-extraction treatment of cake 24 may include one or more additional metal-reduction or constituent-removal processes, used alone or in combination with iron sponge 40. Such processes may include ion exchange, electrochemical treatment, membrane filtration, adsorption, or combinations thereof. In some embodiments, the adsorption process includes activated carbon or another sorbent material configured to bind, capture, or reduce heavy metals and other retained chemical constituents. The particular post-treatment process may be selected based on the metal species present, concentration levels, regulatory objectives, disposal requirements, beneficial-reuse objectives, or process economics.

First connection member 26, second connection member 28, and third connection member 30 provide physical and fluid communication between container 12 and first delivery mechanism 14, second delivery mechanism 16, and third delivery mechanism 18, respectively. First connection member 26, second connection member 28, and third connection member 30 may each be rigid or flexible. First connection member 26, second connection member 28, and third connection member 30 may each include valves, couplings, flanges, gaskets, seals, threaded sections, clamps, unions, quick-connect fittings, or welded joints. First connection member 26, second connection member 28, and third connection member 30 may be formed of corrosion-resistant materials such as stainless steel, coated steel, PVC, CPVC, polyethylene, polypropylene, PTFE-lined hose, or fiberglass-reinforced composites. First connection member 26, second connection member 28, and third connection member 30 may be positioned to introduce acidic solution 44, treatment compound 46, and oxidizing agent 48 into common or different regions of container 12 depending on the desired process sequence and distribution profile.

In some embodiments, system 10 also includes controller 200 for process monitoring, sequencing, data handling, or control of one or more treatment operations. Controller 200 may include storage unit 210, processor 220, memory 230, network interface 240, and GPU/FPGA 250. Controller 200 may receive information from metering system 32, pH sensors, flow sensors, oxidation-reduction potential sensors, level sensors, pressure sensors, timers, and other instrumentation associated with container 12, first delivery mechanism 14, second delivery mechanism 16, third delivery mechanism 18, mixing apparatus 20, and extraction unit 22. Storage unit 210 may store treatment recipes, operating histories, test results, alarm conditions, and calibration data. Processor 220 may execute control logic for staged chemical addition, timed mixing, pH adjustment, and dewatering sequences. Memory 230 may temporarily store process variables and user-interface data. Network interface 240 may communicate with plant control systems, local control panels, or remote monitoring systems. GPU/FPGA 250 may be used for accelerated processing of monitoring data, visualization, predictive treatment analysis, or high-speed control tasks in some embodiments, although simpler controller 200 architectures may also be used.

User device 62 may communicate with controller 200 directly or indirectly and may present treatment results, batch status, pH profiles, contaminant-reduction results, alarms, operating settings, throughput data, and maintenance information. User device 62 may be a tablet, touchscreen display, smartphone, laptop computer, industrial terminal, desktop computer, or another operator-facing device. User device 62 may display information associated with system 10 in real time or after completion of a treatment cycle. User device 62 may also allow an operator to review historical treatment results, select treatment recipes, acknowledge alarms, or view output data associated with cake 24, treated filtrate 64, contaminant reduction, or chemical consumption.

System 10 is suitable for a wide range of applications beyond conventional municipal biosolids processing. System 10 may be used in industrial wastewater treatment for sludges containing metal contaminants or high odor loads. System 10 may be used in disaster-response or temporary treatment operations where biological contamination and odor reduction are important. System 10 may be used in agricultural or food-processing waste streams that share similar treatment challenges with sewage sludge. System 10 may also be used where a treated output is intended for beneficial reuse as a fertilizer compound, a cement compound, a construction-related additive, or another value-added material. The treatment sequence carried out by system 10 may reduce environmental risk, reduce odor nuisance, improve sanitation, improve solids handling, and expand the practical end uses of treated sludge-derived materials.

In some embodiments, system 10 may be applied to waste streams other than sewage sludge, including biosolids, soil residual wash effluent, landfill leachate, fats, oils, and grease-containing wastewater, poultry-processing wastewater, and other aqueous or semi-aqueous waste streams containing organic contaminants, heavy metals, PFAS-related compounds, PFOS, PFOA, volatile organic compounds, semi-volatile organic compounds, or combinations thereof. In such embodiments, acidic solution 44, treatment compound 46, and oxidizing agent 48 may be used in a liquid-phase treatment stage to condition the waste stream, oxidize contaminants, promote transfer of selected contaminants from solids or organic mass into a liquid fraction or treated filtrate 64, and facilitate downstream separation, degradation, stabilization, or removal of contaminants from solid and liquid phases. The same treatment chemistry described herein for sewage sludge may therefore be adapted for use with a variety of contaminated waste streams that include suspended solids, dissolved contaminants, emulsified organics, or combinations thereof.

In some embodiments, system 10 is applied to biosolids management such that acidic solution 44, treatment compound 46, and oxidizing agent 48 are introduced into a liquid biosolids stream prior to or during separation. In such embodiments, the treatment chemistry may oxidize heavy metals, reduce pathogen content, reduce odor-causing compounds, and promote transfer of PFAS-related compounds, PFOS, PFOA, and other chemical constituents into a liquid fraction or treated filtrate 64 for further treatment or removal. A resulting solids fraction or cake 24 may thereby have reduced heavy metal concentrations, reduced pathogen content, and reduced chemical contaminant levels relative to untreated biosolids. In some embodiments, the treated biosolids or cake 24 may be suitable for downstream handling, disposal, land application, fertilizer-related use, or other beneficial reuse.

In some embodiments, system 10 is applied to soil residuals, including wash plant effluent and other soil-washing residual streams. In such embodiments, acidic solution 44, treatment compound 46, and oxidizing agent 48 may be introduced into a liquid holding tank or other treatment vessel containing the residual stream so that volatile organic compounds, semi-volatile organic compounds, heavy metals, PFAS-related compounds, PFOS, PFOA, and other contaminants are reduced, oxidized, destabilized, or transferred into a liquid fraction for further treatment. The disclosed chemistry may therefore be used to reduce the contaminant burden associated with both the liquid stream and the associated soil residual solids, thereby improving the condition of the residual solids and preparing the liquid phase for subsequent polishing, clarification, or discharge-related treatment.

In some embodiments, system 10 is applied to landfill leachate. In such embodiments, acidic solution 44, treatment compound 46, and oxidizing agent 48 may be introduced into the raw leachate stream to oxidize contaminants, reduce odor-causing and dissolved organics, and promote transfer, destabilization, or conditioning of heavy metals and PFAS-related compounds in the liquid phase. In some embodiments, a secondary treatment stage follows the initial treatment stage described herein, and the secondary treatment stage may include additional oxidation, settling, filtration, ultraviolet treatment, or other polishing treatment to further reduce PFAS-related compounds, PFOS, PFOA, heavy metals, dissolved contaminants, or residual organics. The resulting treated leachate may therefore be clarified, polished, or otherwise conditioned for downstream discharge, reuse, or additional treatment.

In some embodiments, system 10 is applied to fats, oils, and grease-containing wastewater, including poultry-processing wastewater and other grease-heavy industrial waste streams. In such embodiments, acidic solution 44, treatment compound 46, and oxidizing agent 48 may be introduced into the wastewater to promote biological and chemical breakdown of complex lipids, proteins, suspended organics, and associated contaminants. In some embodiments, the disclosed treatment chemistry may reduce organic loading, reduce odor-causing compounds, condition solids, and promote transfer or reduction of PFAS-related compounds, persistent organic pollutants, and heavy metals. In some embodiments, a downstream polishing or degradation stage may be used to further reduce residual contaminants in the liquid fraction. The treated output may thereby include a clarified liquid phase, a separated solids phase, a filtered metal-bearing fraction, or combinations thereof, depending on the composition of the incoming waste stream and the selected downstream treatment sequence.

These additional embodiments show that the disclosed chemistry may be used not only for sewage sludge treatment, but also for treatment of multiple contaminated waste streams in which oxidation, contaminant transfer, solids conditioning, pathogen reduction, odor reduction, and downstream separation are desired. The particular sequence, dosing profile, treatment intensity, settling interval, dewatering conditions, and downstream polishing stages may be selected based on the specific waste stream, contaminant profile, regulatory objective, and intended final disposition of the treated material.

In some embodiments, a treated liquid fraction, clarified liquid, or treated filtrate 64 produced by system 10 may be used in environmental remediation applications, including post-wildfire treatment of burned land areas. For example, the treated liquid fraction may be applied to charred soil, ash-bearing ground, or fire-damaged terrain to condition the soil, reduce dust, provide moisture retention, support revegetation, and assist in reseeding operations. In some embodiments, the treated liquid fraction is sprayed, injected, dispersed, or otherwise applied to burned areas before, during, or after distribution of seed so that the treated liquid fraction supports establishment of vegetation on wildfire-affected ground. The treated liquid fraction may therefore be used not only as a byproduct of the treatment process, but also as a useful output for land-restoration and erosion-control applications.

In some embodiments, a treated liquid fraction, clarified liquid, or treated filtrate 64 produced by system 10 is subjected to a secondary polishing treatment after separation from cake 24. The secondary polishing treatment may include exposing the treated liquid fraction to UV-C irradiation, for example at wavelengths in a range of about 200 nm to about 280 nm, and introducing hydrogen peroxide thereto, such as a hydrogen peroxide solution having a concentration of about 35%. In some embodiments, the UV-C irradiation and hydrogen peroxide are used together as an advanced oxidation treatment to further reduce residual organic contaminants, microorganisms, PFAS-related compounds, odor-causing constituents, color, or other residual chemical species remaining in the treated liquid fraction before discharge, reuse, land application, environmental remediation, or further treatment.

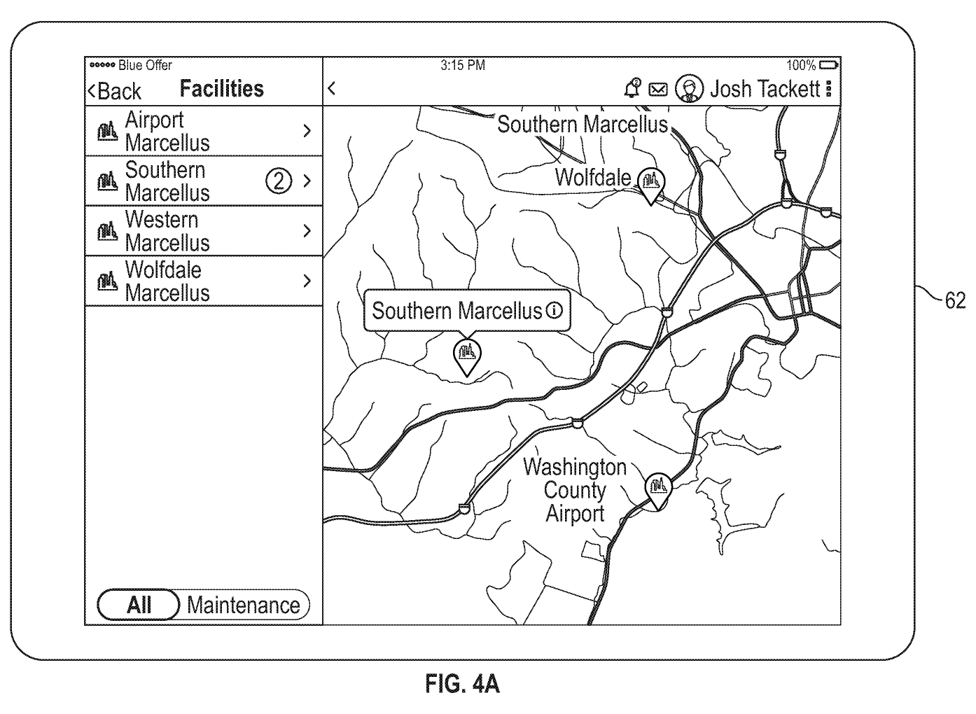

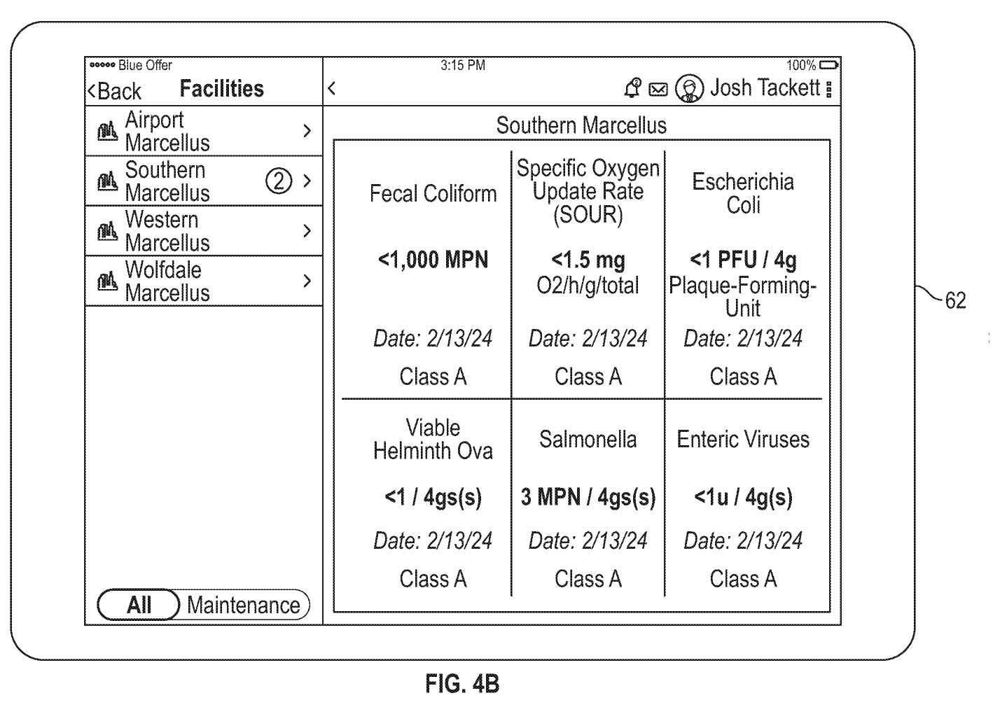

Referring now to FIGS. 4A and 4B, user device 62 is shown, in accordance with aspects of the present disclosure. User device 62 may be a tablet, a mobile phone, a smartphone, a laptop computer, a desktop computer, an industrial touchscreen terminal, or another computing device configured to present information associated with system 10 to an operator, technician, supervisor, or other authorized user. In some embodiments, user device 62 executes or accesses an application that displays treatment information generated by system 10, including information associated with container 12, first delivery mechanism 14, second delivery mechanism 16, third delivery mechanism 18, mixing apparatus 20, extraction unit 22, metering system 32, acidic solution 44, treatment compound 46, oxidizing agent 48, cake 24, and volume of sewage sludge 42. User device 62 may communicate with controller 200 through network interface 240, through a local network, through a wireless connection, through a cloud-based connection, or through another wired or wireless communication pathway.

As shown in FIGS. 4A and 4B, user device 62 may present treatment results through a dedicated software application, dashboard, browser-based interface, or plant-monitoring interface. The application displayed on user device 62 may organize treatment information by site, plant, tank, batch, date, time, compound, contaminant category, operator, or treatment status. In some embodiments, user device 62 displays results on a per-site basis so that a user can review information associated with multiple treatment locations, treatment trains, or containers 12 from a single interface. In some embodiments, user device 62 displays results on a per-compound basis so that a user can review acidic solution 44 usage, treatment compound 46 usage, oxidizing agent 48 usage, dosing history, feed rates, or treatment recipes associated with a selected treatment event. In some embodiments, user device 62 displays treatment outcomes such as pH reduction, oxidation-reduction potential trends, fecal coliform reduction, heavy metal reduction, PFAS-related contaminant results, PFOS results, PFOA results, cake 24 output volume, treated filtrate 64 output, and other treatment-performance data.

User device 62 may also present graphical information associated with operation of system 10. For example, user device 62 may display time-based graphs showing pH changes within volume of sewage sludge 42 during delivery of acidic solution 44, graphs showing chemical addition timing for first delivery mechanism 14, second delivery mechanism 16, and third delivery mechanism 18, and process-status indicators associated with mixing apparatus 20 and extraction unit 22. User device 62 may display tables, charts, summaries, alarms, warnings, treatment-completion notifications, maintenance reminders, or quality-control data. In some embodiments, the application on user device 62 allows the user to select a site and then drill down to a particular batch, a particular container 12, a particular treatment cycle, or a particular contaminant-reduction result. In some embodiments, the application on user device 62 presents a batch history that allows comparison of treatment cycles across different days, different sludge sources, different treatment compound 46 formulations, different oxidizing agent 48 chemistries, or different operating settings.

User device 62 may support operational decision-making and recordkeeping associated with system 10. In some embodiments, user device 62 allows a user to review historical treatment results to determine whether a selected site or a selected batch achieved a desired pH range, a desired microbial reduction level, a desired heavy metal reduction level, or another desired treatment outcome. In some embodiments, user device 62 allows the user to compare results between different facilities, different site conditions, different chemical ratios, or different sludge compositions. In some embodiments, user device 62 presents information in a format suitable for regulatory reporting, internal compliance review, customer reporting, plant optimization, or verification of beneficial reuse suitability. User device 62 may also display photographs, sample identifiers, laboratory test results, operator notes, timestamps, geolocation information associated with a site, or other metadata relevant to the treatment event.

In some embodiments, user device 62 provides a user interface through which an operator can enter information associated with incoming volume of sewage sludge 42, select a treatment recipe, identify the source site, identify the intended downstream use of cake 24, or confirm completion of one or more treatment stages. In some embodiments, user device 62 receives information from controller 200 in substantially real time so that the application can update during treatment. In some embodiments, user device 62 receives information after completion of a batch so that results may be reviewed later by an operator, manager, regulator, or customer. User device 62 may therefore provide a practical and accessible way to visualize, track, compare, archive, and communicate results generated by system 10 across one or more sites and one or more treatment operations.

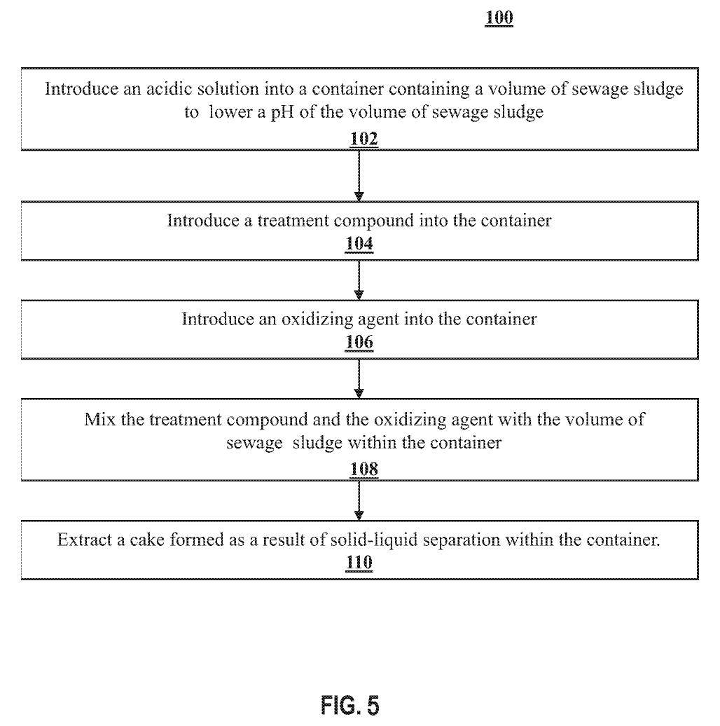

Referring now to FIG. 5, a method 100 for treating sewage sludge is shown, in accordance with aspects of the present disclosure. Method 100 may be carried out using system 10 to reduce pathogens, odor-causing compounds, organic contaminants, heavy metals, PFAS-related contaminants, and other undesirable constituents present in volume of sewage sludge 42, while also promoting solid-liquid separation and formation of cake 24 for extraction, disposal, further treatment, or beneficial reuse. Method 100 may be carried out as a batch treatment process, a semi-batch treatment process, a staged treatment process, or a treatment cycle coordinated with upstream or downstream wastewater-treatment operations. Method 100 may be used with municipal sewage sludge, liquid biosolids, digested sewage sludge, undigested sewage sludge, partially thickened sludge, and other sludge streams encountered in wastewater treatment. Method 100 may be performed at a fixed treatment installation, at a portable treatment installation, or at another treatment site where contaminant reduction and solids conditioning are desired.

Block 102 includes introducing acidic solution 44 into container 12 containing volume of sewage sludge 42 to lower a pH of volume of sewage sludge 42. Introducing acidic solution 44 may include delivering acidic solution 44 through first delivery mechanism 14 and through first connection member 26 into container 12 before introduction of treatment compound 46 and oxidizing agent 48. Introducing acidic solution 44 may include continuously dosing acidic solution 44, intermittently dosing acidic solution 44, pulse-dosing acidic solution 44, or delivering acidic solution 44 in one or more batch additions. Introducing acidic solution 44 may include mixing acidic solution 44 with volume of sewage sludge 42 as acidic solution 44 is added so that pH reduction occurs more uniformly throughout container 12. Acidic solution 44 may include a mixture of an inorganic acid and an organic acid. Acidic solution 44 may include muriatic acid, sulfuric acid, hydrochloric acid, nitric acid, phosphoric acid, lactic acid, citric acid, or combinations thereof. Introducing acidic solution 44 may reduce the pH of volume of sewage sludge 42 to a value between about 2.9 and about 3.3. Introducing acidic solution 44 may inhibit biological activity, condition solids, release bound contaminants, suppress odors, and improve the effectiveness of subsequent treatment with treatment compound 46 and oxidizing agent 48. In some embodiments, introducing acidic solution 44 further includes monitoring pH in real time using metering system 32 and adjusting delivery of acidic solution 44 based on sensed pH conditions within container 12.

Block 104 includes introducing treatment compound 46 into container 12. Introducing treatment compound 46 may include delivering treatment compound 46 through second delivery mechanism 16 and through second connection member 28 into container 12 after acidic solution 44 has conditioned volume of sewage sludge 42. Introducing treatment compound 46 may include delivering treatment compound 46 as a dissolved formulation, a concentrated aqueous formulation, a slurry, a suspension, or another deliverable chemical form. Treatment compound 46 may include aluminum sulfate, copper sulfate, and zinc sulfate. Treatment compound 46 may include aluminum sulfate as a majority component by weight. Treatment compound 46 may have a pH between about 1.9 and about 2.1. In one representative implementation derived from the disclosed treatment chemistry, treatment compound 46 may be prepared in an amount of about 84 gallons for treatment of about 10,000 gallons of liquid biosolids, plus or minus about 3,000 gallons, and may include about 68 pounds of aluminum sulfate, plus or minus about 5 pounds, about 34 pounds of copper sulfate, plus or minus about 3 pounds, and about 8.5 pounds of zinc sulfate, plus or minus about 1 pound, mixed with about 80 gallons of water, thereby providing a representative metal sulfate ratio of about 8:4:1 by weight. Introducing treatment compound 46 may promote coagulation, flocculation, contaminant precipitation, solids conditioning, phosphorus-related treatment effects, and antimicrobial activity within volume of sewage sludge 42. Introducing treatment compound 46 may be carried out at one injection point, at multiple injection points, or in staged additions distributed through container 12.

Block 106 includes introducing oxidizing agent 48 into container 12. Introducing oxidizing agent 48 may include delivering oxidizing agent 48 through third delivery mechanism 18 and through third connection member 30 into container 12 after introduction of acidic solution 44 and treatment compound 46, or in a partially overlapping sequence with introduction of treatment compound 46. Introducing oxidizing agent 48 may include introducing oxidizing agent 48 in gaseous form, liquid form, dissolved form, or another reactive form selected for the treatment chemistry. Oxidizing agent 48 may include ozone, hydrogen peroxide, peracetic acid, potassium permanganate, sodium hypochlorite, chlorine dioxide, a persulfate, or combinations thereof. In some embodiments, introducing oxidizing agent 48 includes introducing oxidizing agent 48 at a rate of about 0.05 grams per hour to about 5 grams per hour per 1,000 gallons of volume of sewage sludge 42 being treated. In some embodiments, introducing oxidizing agent 48 includes adding oxidizing agent 48 at a plurality of corners or peripheral regions of container 12 to improve distribution and reduce dead zones. Introducing oxidizing agent 48 may oxidize reduced sulfur species, odor-causing organics, microbial matter, and other contaminants, while also assisting with disinfection, odor reduction, stabilization, and improved dewaterability of the treated material.

Block 108 includes mixing treatment compound 46 and oxidizing agent 48 with volume of sewage sludge 42 within container 12. Mixing treatment compound 46 and oxidizing agent 48 with volume of sewage sludge 42 may include operating mixing apparatus 20 within container 12 after introduction of acidic solution 44, treatment compound 46, and oxidizing agent 48. Mixing treatment compound 46 and oxidizing agent 48 with volume of sewage sludge 42 may include distributing the introduced materials through volume of sewage sludge 42 so that chemical contact, reaction, oxidation, solids conditioning, and contaminant reduction occur more uniformly. Mixing treatment compound 46 and oxidizing agent 48 with volume of sewage sludge 42 may include aerating volume of sewage sludge 42 with aerator 36. Mixing treatment compound 46 and oxidizing agent 48 with volume of sewage sludge 42 may include operating mechanical agitator 38 positioned within container 12. Mixing treatment compound 46 and oxidizing agent 48 with volume of sewage sludge 42 may include a one-stage mixing sequence in which treatment compound 46 and oxidizing agent 48 are mixed substantially together, or a multi-stage mixing sequence in which treatment compound 46 is mixed first and oxidizing agent 48 is mixed later, or oxidizing agent 48 is mixed first and treatment compound 46 is mixed later. Mixing treatment compound 46 and oxidizing agent 48 with volume of sewage sludge 42 may continue for a selected period sufficient to promote reaction and conditioning, after which container 12 may be allowed to settle for a predetermined period so that solid-liquid separation progresses and cake 24 forms.

Block 110 includes extracting cake 24 formed as a result of solid-liquid separation within container 12. Extracting cake 24 may include removing cake 24 through extraction unit 22 after settling, conditioning, or dewatering. Extracting cake 24 may include passing treated material through dewatering device 34. Dewatering device 34 may be a filter press, a belt press, a centrifuge, a screw press, or another dewatering machine. Extracting cake 24 may also include removing cake 24 through a bottom discharge port of container 12, by suction, by vacuum-assisted withdrawal, or by another solids-removal arrangement. Extracting cake 24 may include separating a liquid fraction from a solids fraction and collecting cake 24 for disposal, further treatment, or beneficial reuse. Extracting cake 24 may produce a treated solid output having reduced fecal coliform content, reduced odor-causing compounds, reduced heavy metal content, and reduced PFAS-related contaminant levels relative to untreated volume of sewage sludge 42. In representative disclosed results, treatment carried out according to method 100 may reduce fecal coliform concentration to less than about 100 MPN per 100 mL and in some cases to less than about 1 MPN per 100 mL after treatment and settling, and may also reduce selected heavy metals and PFOS/PFOA to non-detectable levels in representative treated material.

In embodiments, method 100 may further include lowering the pH of volume of sewage sludge 42 to a value between about 2.9 and about 3.3. Lowering the pH of volume of sewage sludge 42 may be carried out during block 102 through controlled introduction of acidic solution 44 and may be monitored by metering system 32. Lowering the pH of volume of sewage sludge 42 may provide improved chemical conditioning, suppression of undesirable biological activity, improved odor control, and improved downstream reaction performance.

In embodiments, method 100 may further include introducing acidic solution 44 as a mixture of an inorganic acid and an organic acid. Introducing acidic solution 44 as a mixture of an inorganic acid and an organic acid may provide a selected acidification profile, may improve compatibility with treatment chemistry, and may be adjusted based on buffering capacity and contaminant composition of volume of sewage sludge 42.

In embodiments, method 100 may further include introducing treatment compound 46 including aluminum sulfate, copper sulfate, and zinc sulfate. Introducing treatment compound 46 including aluminum sulfate, copper sulfate, and zinc sulfate may provide a coordinated combination of coagulation behavior, precipitation behavior, and antimicrobial behavior. Introducing treatment compound 46 including aluminum sulfate, copper sulfate, and zinc sulfate may also include selecting a ratio of these compounds based on treatment objectives, plant operating conditions, solids content, odor load, or contaminant load of volume of sewage sludge 42. In some embodiments, introducing treatment compound 46 further includes selecting a representative ratio of about 8:4:1 by weight.

In embodiments, method 100 may further include selecting treatment compound 46 to have a pH between about 1.9 and about 2.1. Selecting treatment compound 46 to have a pH between about 1.9 and about 2.1 may support the disclosed coordinated treatment chemistry and may improve interaction between treatment compound 46, acidic solution 44, oxidizing agent 48, and contaminants within volume of sewage sludge 42.

In embodiments, method 100 may further include introducing oxidizing agent 48 including ozone, hydrogen peroxide, peracetic acid, potassium permanganate, sodium hypochlorite, chlorine dioxide, a persulfate, or combinations thereof. Introducing oxidizing agent 48 including one or more of these chemistries may be selected based on oxidation strength, site safety considerations, chemical compatibility, availability, cost, desired reaction kinetics, and target contaminant profile.

In embodiments, method 100 may further include mixing by aerating volume of sewage sludge 42. Mixing by aerating volume of sewage sludge 42 may include distributing air or another gas through aerator 36 to promote circulation, improve chemical contact, reduce anaerobic odor formation, and in some cases introduce gaseous oxidizing agent 48.

In embodiments, method 100 may further include mixing by operating mechanical agitator 38 positioned within container 12. Mixing by operating mechanical agitator 38 positioned within container 12 may include rotating one or more impellers, paddles, propellers, or other driven mixing elements to distribute acidic solution 44, treatment compound 46, and oxidizing agent 48 through volume of sewage sludge 42. Mixing by operating mechanical agitator 38 positioned within container 12 may be particularly useful for higher-solids or higher-viscosity sludge streams.

In embodiments, method 100 may further include treating cake 24 with iron sponge 40 to reduce a concentration of excess heavy metals and other chemical constituents retained in cake 24. Treating cake 24 with iron sponge 40 may be carried out after block 110 in a polishing step, a secondary treatment step, or a post-dewatering treatment step. Treating cake 24 with iron sponge 40 may further stabilize retained contaminants and improve suitability of cake 24 for disposal or beneficial reuse.

In embodiments, method 100 may further include processing cake 24 for reuse. Processing cake 24 for reuse may include converting cake 24 into a fertilizer compound, a cement compound, a construction-related additive, or another reusable product. Processing cake 24 for reuse may be carried out after dewatering, after treatment with iron sponge 40, or after additional drying, blending, pelletizing, thermal treatment, or stabilization steps. Method 100 may therefore support reduction of environmental burden while also supporting conversion of treated sewage sludge into a useful downstream material.

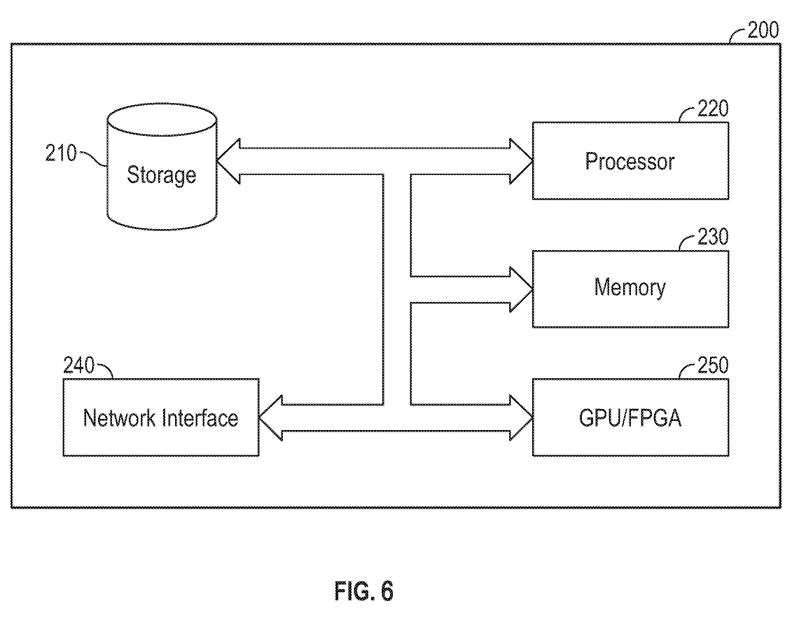

Referring now to FIG. 6, controller 200 is shown, in accordance with aspects of the present disclosure. Controller 200 is arranged to coordinate, regulate, monitor, and record operation of system 10 during treatment of volume of sewage sludge 42 and during formation and extraction of cake 24. Controller 200 may communicate with and manage first delivery mechanism 14, second delivery mechanism 16, third delivery mechanism 18, mixing apparatus 20, extraction unit 22, and metering system 32 so that addition of acidic solution 44, treatment compound 46, and oxidizing agent 48 occurs in a controlled sequence and under selected operating conditions. Controller 200 may also coordinate operation with user device 62 so that treatment information, batch information, site information, chemical usage information, and treatment results are displayed locally or remotely. Controller 200 includes storage unit 210, processor 220, memory 230, network interface 240, and GPU/FPGA 250. These elements operate together to support execution of treatment recipes, control of chemical-addition timing and dosing, monitoring of pH and related process conditions, coordination of mixing and extraction operations, and recording of treatment results for traceability, repeatability, and review. Controller 200 may be mounted locally as part of system 10, may be arranged as a panel-mounted or rack-mounted control unit, or may operate as a networked supervisory controller 200 in communication with one or more local control modules.

Storage unit 210 provides nonvolatile data retention for controller 200 and serves as a repository for treatment recipes, configuration data, calibration data, process logs, and treatment records associated with system 10. Storage unit 210 may store firmware, software, operating profiles, batch histories, site identifiers, site-specific treatment settings, pH targets, oxidation-reduction potential targets, chemical-addition schedules, mixing durations, settling durations, extraction parameters, alarm histories, maintenance histories, and user-entered notes. Storage unit 210 may also store data associated with acidic solution 44, treatment compound 46, and oxidizing agent 48, including selected compound types, dosing quantities, feed rates, selected ratios, and representative formulations. For example, storage unit 210 may store a treatment recipe associated with treatment compound 46 including aluminum sulfate, copper sulfate, and zinc sulfate, and may store a representative ratio of about 8:4:1 by weight for those compounds. Storage unit 210 may further store treatment results such as pH histories, fecal coliform results, heavy metal results, PFAS-related results, PFOS results, PFOA results, cake-output data, dewatering data, treated filtrate 64 data, and timestamps associated with individual treatment cycles. Storage unit 210 may include one or more solid-state drives, flash-memory devices, industrial memory modules, or other nonvolatile storage devices selected for reliable operation in plant environments, vibration environments, and repeated power-cycling environments. Storage unit 210 may also support checksum verification, write protection for validated treatment recipes, user-level access restrictions, and structured data organization for quality-control review, regulatory documentation, and process optimization.

Processor 220 provides centralized computational control for controller 200. Processor 220 may be a microprocessor, microcontroller, digital signal processor, industrial control processor, programmable logic controller processor, or another computational unit selected for process-control applications. Processor 220 may execute embedded control software, supervisory-control routines, batch-treatment routines, alarm-management routines, data-logging routines, and communication routines. Processor 220 may coordinate first delivery mechanism 14, second delivery mechanism 16, and third delivery mechanism 18 so that acidic solution 44, treatment compound 46, and oxidizing agent 48 are introduced into container 12 in a selected sequence and in selected amounts. Processor 220 may also coordinate mixing apparatus 20 so that aerator 36, mechanical agitator 38, or both operate according to a selected treatment profile. Processor 220 may further coordinate extraction unit 22 so that extraction of cake 24 occurs after a selected settling interval, dewatering interval, or treatment-completion condition. Processor 220 may execute control logic that responds to pH readings, oxidation-reduction potential readings, flow conditions, level conditions, pressure conditions, and alarm inputs. Processor 220 may also apply process-specific logic based on site, sludge type, solids concentration, desired contaminant reduction, intended downstream use of cake 24, or a selected treatment recipe. In some embodiments, processor 220 carries out interlock functions, such as preventing addition of treatment compound 46 until acidic solution 44 has reduced pH to a selected range, preventing extraction until settling or dewatering conditions are met, and shutting down one or more delivery mechanisms when out-of-range conditions are detected.

Memory 230 is operatively connected to processor 220 and provides storage for runtime data, temporary control variables, active process parameters, software routines, and treatment-state information. Memory 230 may include random-access memory, cache memory, working memory, or other volatile or semi-volatile storage used during active operation of controller 200. Memory 230 may buffer incoming sensor data from metering system 32, including pH values, oxidation-reduction potential values, and flow or dosing data associated with first delivery mechanism 14, second delivery mechanism 16, and third delivery mechanism 18. Memory 230 may also store active batch identifiers, current treatment-step status, current site information, current chemical-usage totals, and recent operational histories for system 10. Memory 230 may store intermediate calculations used by processor 220 to determine whether a target pH range has been achieved, whether a selected amount of treatment compound 46 has been delivered, whether oxidizing agent 48 is being added at the proper rate, or whether mixing apparatus 20 has run for a sufficient interval. Memory 230 may also maintain short-term process histories and rolling windows of recent values that support adaptive adjustments, alarm thresholds, or process-stability checks during treatment of volume of sewage sludge 42. In embodiments using user device 62 to present treatment data, memory 230 may store active graphical data, dashboard data, user-interface fields, and recent results pending communication to user device 62.

Network interface 240 provides wired or wireless connectivity between controller 200 and external systems, including user device 62, plant-control systems, site-management systems, supervisory control and data acquisition systems, cloud-based monitoring platforms, remote support systems, or regulatory-reporting systems. Through network interface 240, an operator may load treatment recipes, select site-specific treatment profiles, initiate treatment cycles, review operating conditions, retrieve logs, modify schedules, view alarms, and access historical treatment results. Network interface 240 may support communication of pH data, oxidation-reduction potential data, dosing data, mixing status, extraction status, cake-output information, treated filtrate 64 information, contaminant-reduction results, and chemical-usage summaries. Network interface 240 may include Ethernet communication hardware, wireless communication hardware, serial communication hardware, fiber communication hardware, industrial fieldbus interfaces, or other communication interfaces suitable for installation at a wastewater-treatment site or industrial-treatment facility. Network interface 240 may support remote monitoring of multiple treatment sites and may allow system 10 to be managed across a distributed fleet of treatment installations. Network interface 240 may also support communication with user device 62 so that a tablet, phone, laptop, desktop system, or industrial display can present treatment results by site, by batch, by date, by compound, by contaminant category, or by intended reuse pathway for cake 24.

GPU/FPGA 250 is coupled to processor 220 and may provide hardware-accelerated processing for deterministic control, data analysis, visualization support, signal processing, or high-speed process coordination associated with system 10. GPU/FPGA 250 may be used to accelerate processing of incoming treatment data, including pH trends, oxidation-reduction potential trends, dosing histories, treatment-status timelines, extraction data, and user-interface graphics presented through user device 62. GPU/FPGA 250 may also provide low-latency control support for synchronized operation of first delivery mechanism 14, second delivery mechanism 16, third delivery mechanism 18, mixing apparatus 20, and extraction unit 22 when precise sequencing is desired. In some embodiments, GPU/FPGA 250 may execute predictive or optimization routines that compare current treatment conditions with stored recipes and stored historical outcomes so that processor 220 can recommend or implement recipe adjustments. GPU/FPGA 250 may also support accelerated analysis of contaminant-reduction datasets, comparison across treatment sites, trend analysis across batches, and rendering of graphical dashboards for user device 62. In some embodiments, GPU/FPGA 250 is omitted and controller 200 relies on processor 220 alone. In other embodiments, GPU/FPGA 250 is used where a higher degree of automation, faster data handling, or expanded visualization capability is desired.

In some embodiments, controller 200 is communicatively coupled to metering system 32 so that controller 200 receives pH data and optionally oxidation-reduction potential data from container 12 during introduction of acidic solution 44. Controller 200 may then adjust operation of first delivery mechanism 14 so that acidic solution 44 is delivered until volume of sewage sludge 42 reaches a target pH range, for example between about 2.9 and about 3.3. Controller 200 may also coordinate delivery of treatment compound 46 through second delivery mechanism 16 and delivery of oxidizing agent 48 through third delivery mechanism 18 based on the treatment stage, the selected recipe, the source of volume of sewage sludge 42, or one or more measured treatment conditions. Controller 200 may further coordinate operation of mixing apparatus 20 so that aerator 36, mechanical agitator 38, or both are activated during selected phases of the treatment cycle. Controller 200 may also initiate or authorize operation of extraction unit 22 once solid-liquid separation has progressed sufficiently or once a target treatment condition has been reached. In some embodiments, controller 200 may coordinate post-treatment handling of cake 24, including routing of cake 24 to a dewatering device 34, a collection point, an iron sponge 40 treatment stage, a fertilizer-processing stage, or a cement-compound processing stage.

During operation, processor 220 may execute routines stored in memory 230 and treatment recipes stored in storage unit 210 to coordinate the system elements of system 10. A representative treatment sequence may include identifying a site or batch, confirming that container 12 contains a selected volume of sewage sludge 42, confirming readiness of first delivery mechanism 14, second delivery mechanism 16, third delivery mechanism 18, mixing apparatus 20, and extraction unit 22, loading a treatment recipe, introducing acidic solution 44, monitoring pH using metering system 32, introducing treatment compound 46, introducing oxidizing agent 48, actuating mixing apparatus 20 for a selected interval, allowing settling for a selected interval, initiating extraction through extraction unit 22, and recording the completed treatment results. When treatment results are available, controller 200 may associate those results with a site identifier, a batch identifier, a recipe identifier, a date, a time, and one or more measured treatment outcomes. Controller 200 may then transmit those results to user device 62 for local or remote display.

Through these coordinated functions, controller 200 supports repeatable treatment of volume of sewage sludge 42, repeatable reduction of contaminants, repeatable formation and extraction of cake 24, and repeatable documentation of treatment results. Integration of storage unit 210, processor 220, memory 230, network interface 240, and GPU/FPGA 250 supports controlled operation of system 10 across a range of treatment conditions, sludge compositions, chemical formulations, site environments, and downstream-use objectives. Controller 200 therefore provides a practical control and data-management framework for implementing, monitoring, documenting, and refining operation of system 10.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for treating sewage sludge, comprising:
a container configured to receive a volume of sewage sludge;
a first delivery mechanism configured to deliver an acidic solution to the container to lower a pH of the volume of sewage sludge;
a second delivery mechanism configured to deliver a treatment compound to the container;
a third delivery mechanism configured to deliver an oxidizing agent to the container;
a mixing apparatus configured to mix the treatment compound and the oxidizing agent with the volume of sewage sludge within the container; and
an extraction unit configured to extract a cake formed as a result of solid-liquid separation within the container.

2. The system of claim 1, wherein the acidic solution comprises a mixture of an inorganic acid and an organic acid, and wherein the acidic solution comprises muriatic acid, sulfuric acid, hydrochloric acid, nitric acid, phosphoric acid, lactic acid, citric acid, or a combination thereof.

3. The system of claim 2, wherein the first delivery mechanism is configured to be connected to the container by a first connection member, wherein the second delivery mechanism is configured to be connected to the container by a second connection member, and wherein the third delivery mechanism is configured to be connected to the container by a third connection member.

4. The system of claim 1, wherein the container is one of a concrete tank, a steel tank, a polymer tank, a batch reactor, a continuous stirred tank reactor, an anaerobic digester tank, or an aerobic digester tank.

5. The system of claim 1, wherein the first delivery mechanism is configured to deliver the acidic solution to lower the pH of the sewage sludge to a value between about 2.9 and about 3.3.

6. The system of claim 1, wherein the first delivery mechanism comprises a metering system configured to monitor and adjust pH in real time.

7. The system of claim 1, wherein the treatment compound comprises aluminum sulfate, copper sulfate, and zinc sulfate, and wherein the treatment compound has a pH between about 1.9 and about 2.1.

8. The system of claim 1, wherein one of the first delivery mechanism, the second delivery mechanism, and the third delivery mechanism is configured to deliver the acidic solution, the treatment compound, and the oxidizing agent, or wherein two of the first delivery mechanism, the second delivery mechanism, and the third delivery mechanism are configured to collectively deliver the acidic solution, the treatment compound, and the oxidizing agent.

9. The system of claim 1, wherein the oxidizing agent comprises ozone, hydrogen peroxide, peracetic acid, potassium permanganate, sodium hypochlorite, chlorine dioxide, a persulfate, or a combination thereof.

10. The system of claim 1, wherein the extraction unit comprises a dewatering device, and wherein the dewatering device is one of a filter press, a belt press, a centrifuge, and a screw press, or a bottom discharge port of the container.

11. A method for treating sewage sludge, comprising:
introducing an acidic solution into a container containing a volume of sewage sludge to lower a pH of the volume of sewage sludge;
introducing a treatment compound into the container;
introducing an oxidizing agent into the container;
mixing the treatment compound and the oxidizing agent with the volume of sewage sludge within the container; and
extracting a cake formed as a result of solid-liquid separation within the container.

12. The method of claim 11, wherein the acidic solution comprises a mixture of an inorganic acid and an organic acid.

13. The method of claim 11, further comprising lowering the pH of the sewage sludge to a value between about 2.9 and about 3.3.

14. The method of claim 11, wherein the treatment compound comprises aluminum sulfate, copper sulfate, and zinc sulfate.

15. The method of claim 14, wherein a pH of the treatment compound is between about 1.9 and about 2.1.

16. The method of claim 11, wherein the oxidizing agent comprises ozone, hydrogen peroxide, peracetic acid, potassium permanganate, sodium hypochlorite, chlorine dioxide, a persulfate, or a combination thereof.

17. The method of claim 11, wherein mixing comprises aerating the sewage sludge.

18. The method of claim 11, wherein mixing comprises operating a mechanical agitator positioned within the container.

19. The method of claim 11, further comprising treating the cake with an iron sponge to reduce a concentration of excess heavy metals and other chemical constituents retained in the cake.

20. A system for treating sewage sludge, comprising:
a container configured to receive a volume of sewage sludge, wherein the container is one of a concrete tank, a steel tank, a polymer tank, a batch reactor, a continuous stirred tank reactor, an anaerobic digester tank, or an aerobic digester tank;
a first delivery mechanism configured to deliver an acidic solution comprising a mixture of an inorganic acid and an organic acid to the container via a first connection member to lower a pH of the volume of sewage sludge to a value between about 2.9 and about 3.3;
a second delivery mechanism configured to deliver a treatment compound comprising aluminum sulfate, copper sulfate, and zinc sulfate to the container via a second connection member, wherein the treatment compound has a pH between about 1.9 and about 2.1;
a third delivery mechanism configured to deliver an oxidizing agent to the container via a third connection member, wherein the oxidizing agent comprises ozone, hydrogen peroxide, peracetic acid, potassium permanganate, sodium hypochlorite, chlorine dioxide, a persulfate, or a combination thereof;
a mixing apparatus positioned within the container and configured to mix the treatment compound and the oxidizing agent with the volume of sewage sludge, wherein the mixing apparatus comprises an aerator or a mechanical agitator; and
an extraction unit configured to extract a cake formed as a result of solid-liquid separation within the container, wherein the extraction unit comprises a dewatering device,
wherein one of the first delivery mechanism, the second delivery mechanism, and the third delivery mechanism is configured to deliver the acidic solution, the treatment compound, and the oxidizing agent, or wherein two of the first delivery mechanism, the second delivery mechanism, and the third delivery mechanism are configured to collectively deliver the acidic solution, the treatment compound, and the oxidizing agent.
